(19) United States
(12) Patent Application Publication
(10) Pub. No.: US 2005/0121929 A1
(43) Pub. Date: Jun. 9, 2005

(54) Humanoid robotics

(76) Inventors: Richard Greenhill, London (GB); Hugo Elias, London (GB); Richard Walker, London (GB); Matthew Godden, Luton (GB)

Correspondence Address: RICHARD GREENHILL, 357 LIVERPOOL ROAD, LONDON, N1 1NL, GB

(21) Appl. No.: 10/951,332

(22) Filed: Sep. 23, 2004

Related U.S. Application Data
(63) Continuation of application No. PCT/GB03/01246, filed on Mar. 24, 2003.

(30) Foreign Application Priority Data
Mar. 25, 2002 (GB) GB 0206974-8

(51) Int. Cl. B25J 15/10

(52) U.S. Cl. 294/106

(57) ABSTRACT

A humanoid forearm and hand configuration has a hand conformation such as to be capable of mimicking substantially all of the movements of the human hand, the several component parts of the hand and the wrist-simulating joint coupling the hand to the radius-seeking joint of the forearm being angularly movable with respect to one another each by separate tendon means connected to respective ones of a large number of tightly packed space-seeking jostling air muscles clustered around a radius-simulating shaft.

### BACKGROUND TO THE INVENTION

This invention relates to humanoid robotics and, more especially, to a robotic forearm and hand configuration.

Whilst the actuation means incorporated as part of the forearm may take other forms, in the hereinafter described embodiment of the forearm of the configuration air muscles are employed in the displacement of structural elements of the robotic hand being elements each of which serves the role of a skeletal bone portion of the hand and wrist-simulating joint.

An air muscle sometimes referred to, variously, as fluidic muscle, rubbertuator, or McKibben muscle, comprises: an expansible tubular chamber, generally of an elastomeric material, most commonly rubber, having an air inlet port and an air exhaust port, a common port being, generally, employed for both of these functions; a braided sheath which embraces said tubular chamber throughout its length; and first and second closure arrangements, at the ends, respectively, of the tubular chamber. The Specification of UK Patent GB No 2255961, dated 13 Mar. 1992, contains a disclosure of a mechanical actuator having an air muscle as above stated, the air muscle serving as actuator traction element.

The air inlet and exhaust porting means of the air muscle may be constituted as a single combined port commonly integral with one or the other of the closure arrangements, but it may be separate from such closure arrangement, being, advantageously, a tapping at the mid-length position of the tubular chamber.

Introduction of air, or other suitable fluid, under pressure, to the chamber causes it to expand rapidly, this, in turn, producing radial expansion, also, of the braided sheath. It is characteristic of the braided sheath, that radial expansion of its expansible tubular chamber is accompanied by a contraction in its length. If the ends of the sheath are respectively coupled, the one to a, possibly movable, datum, a force-reaction part of the actuation system, the other to a system part movable with respect to said reaction part, contraction of the braided sheath gives rise to a tensile force which acts on the movable system part moving it against reaction at the datum force-reaction part in accordance with the extent of contraction in the sheath.

Air muscles need to be pulled out when ‘empty’ (relaxed) in order to be able to deliver their full stroke when inflated. In some cases this extension of the muscle is achieved by a second air muscle coupled to the first, usually acting antagonistically, more often by a conventional mechanical spring arrangement or other similar elastic means which carries out the return movement of a part to be moved. In either circumstance a return movement is effected of the part that has been moved by the air muscle under previous inflation of its tubular chamber. It will be apparent that the muscle and its associated muscle-extension means must, whatever its character, be coupled together, the one acting to pull-out, to extend, the other, and, in turn, to be extended by the other.

A major virtue of the air muscle in the context of humanoid robotics, more particularly the humanoid forearm, is the ability to accommodate within the limited space available, many more actuators of air muscle form than is possible using other types of actuator, of the moving piston variety, for example.

Whilst air muscles have been employed in at least one prior robotic forearm for the actuation of the hand and constituent parts thereof, the degrees of movement available in the prior art arrangement has, notwithstanding the local relatively large number of muscles employed, been quite limited in number, around twelve.

This has arisen, apparently, as a result of the departure in the modelling of the humanoid hand. The humanoid hand to be powered by the several air muscles in the forearm exhibited marked differences from the human hand that it purported to emulate, notably in the number and local relative disposition of the digits and their phalanges. The number degrees of movement in the hand being severely limited, as stated, and each degree of hand movement being under the control of one or, sometimes two, individual air muscles, the number of air muscles present in the forearm and employed in the actuation of the hand and its several (constituent parts was correspondingly small. These muscles were, perforce, supported in the forearm at positions spaced apart around the central shaft, the radius, of the forearm, this by reason, apparently, of the need to prevent or minimise wear arising as a result of abrasive continuous space-seeking jostling contact between the several muscles. The wear referred to has been attributable, in the main, not to contact between the muscle sheaths themselves but to contact between the sheaths and protuberant portions integral with muscle closure end means of the muscles and connection elements adjacent to such closure means.

It has been assessed that for a robotic hand to be able to execute the range of movement achievable by the human hand, it should be able to exhibit twenty four degrees of movement.

The dexterity of the prior art robotic hand has, as a result of its inadequate modelling of the human hand, been incapable of performing many of the movements desirable in the hand, the best known approximation having been twelve degrees of movement.

According to the invention, a robotic forearm and hand configuration is as set out in the claims schedule hereof, and the content of said claims and the inter-dependencies therebetween are to be regarded, notionally, as being set out here, also.

Such robotic forearm and hand configurations are capable of closely mimicking the movements of the human hand, exhibiting, as such configurations do, all twenty-four degrees of movement observed in the hand.

### BRIEF DESCRIPTION OF THE DRAWINGS

A robotic forearm and hand configuration in accordance with the invention is hereinafter described with reference to the accompanying drawings in which:

FIG. 1 is a pictorial diagram of the robotic forearm and hand configuration;

FIG. 2 shows, in plan, a longitudinal section through part of the hand portion, the wrist joint, and certain elements of the forearm;

FIG. 3 shows a part-section taken in the plane III-III of FIG. 2;

FIG. 4 shows, in plan, the hand and the wrist-simulating joint;

FIG. 5 depicts a side view of a finger-simulating digit;

FIG. 6 depicts an edge view of the digit of FIG. 5a;

FIG. 7 depicts a side view of the thumb-simulating digit;

FIG. 8 is a projected plan view of the digit of FIG. 7; and

FIG. 9 shows a detail of the digit of FIGS. 7 and 8.

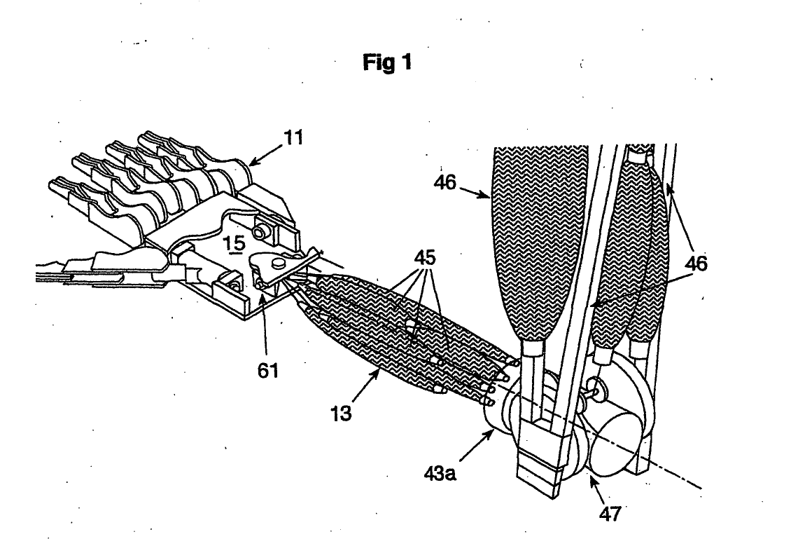

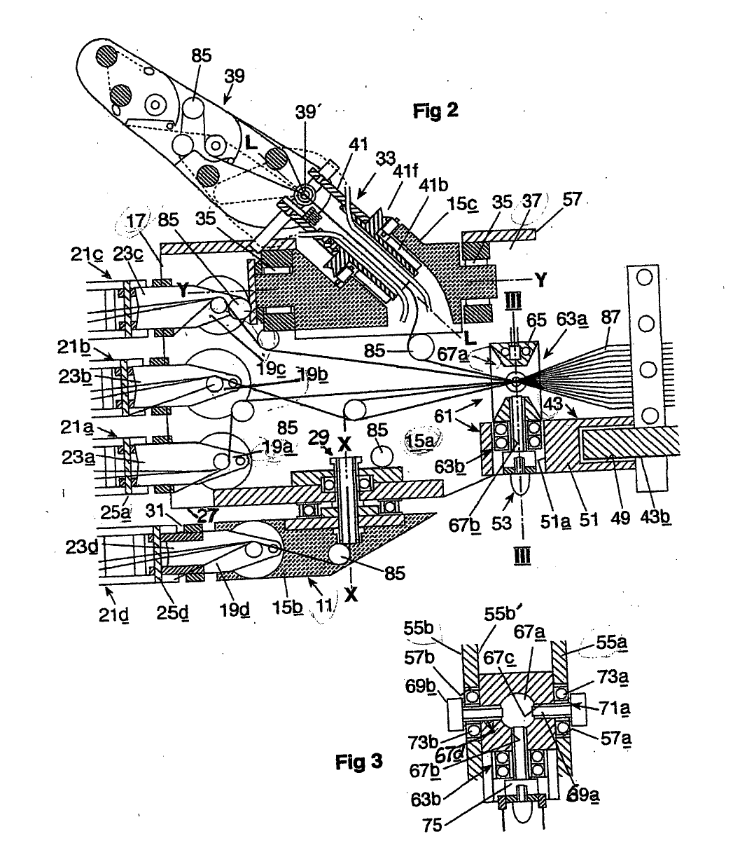

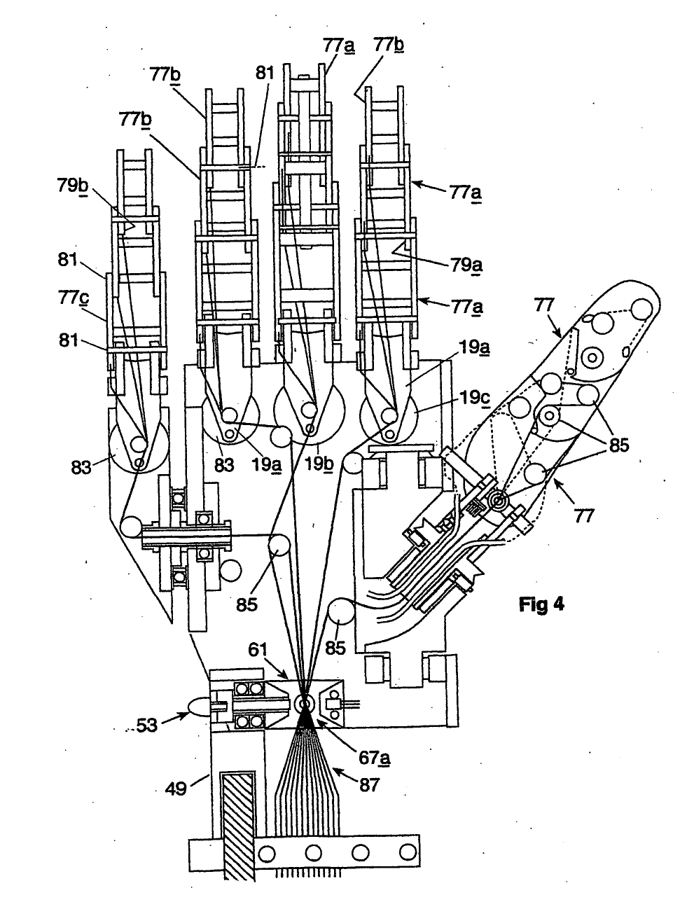

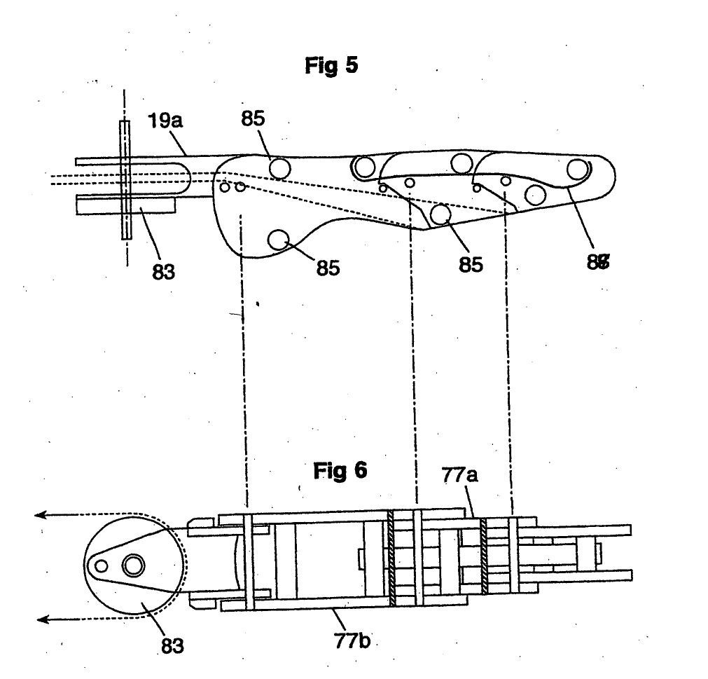

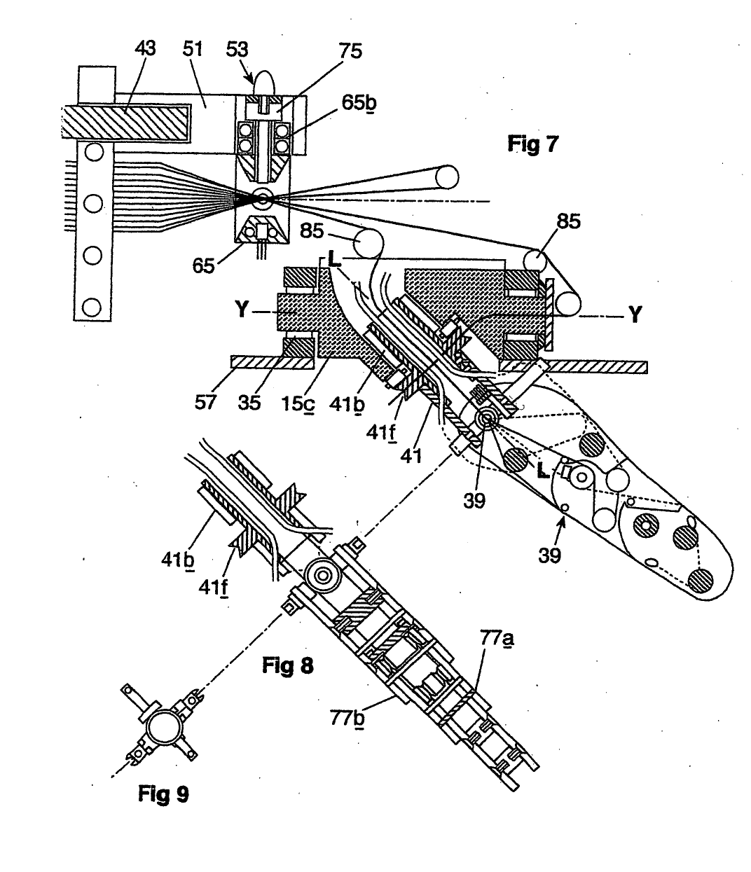

### DESCRIPTION OF A PREFERRED EMBODIMENT OF THE INVENTION

The robotic forearm and hand configuration comprises: a hand portion 11, a forearm portion 13, and means incorporated in said forearm 13 and operative to produce local relative angular movements in the several movable parts of the forearm and hand configuration, all as hereinafter described. The hand portion 11 comprises: a rigid-main palm part 15a; projecting from said palm part 15a at a transversely extensive forward boundary 17 thereof, rigid first, second, and third link elements 19a, 19b, 19c, respectively; first, second and third finger-simulating digits, 21a, 21b, 21c, respectively; first and second auxiliary palm parts 15b, 15c, respectively; a rigid fourth link element 19d; a finger-simulating fourth digit 21d; and a fifth or thumb-simulating digit.

The link elements 19a, 19b, 19c, are respectively pivotally coupled at side by side positions to the main palm part 15 at or adjacent to said forward boundary 17 in such manner as to permit angular movement of said link elements 19a, 19b, 19c, about respective pivot axes substantially normal to the main palm part 15.

The link elements 19a, 19b, 19c, have portions 23a, 23b, 23c, respectively, said portions projecting forwardly of the forward boundary 17.

The digits 21a, 21b, 21c, are respectively pivotally coupled to the link elements 19a, 19b, 19c, at axes, as 25a, extending transversely of the main palm part 15a, orthogonal to the pivot axes of the link elements, as 19a.

The auxiliary palm part 15b is supported adjacent to a first side-boundary 27 of the main palm part 15a at bearing means 29, being bearing means permitting local relative pitch movement of the auxiliary palm part 15b about an axis X - - - X extending transversely of the main palm part 15a.

The fourth link element 19d is pivotally coupled to the auxiliary palm part 15b at a position adjacent to its forward boundary 31, the pivot axis being substantially normal to the plane of the link element 15b, notionally the plane of the drawing. As with the link elements, as 19a, the link element 19d has a portion 23d which projects forwardly of the forward auxiliary palm part boundary 31.

The fourth digit 21d is pivotally coupled to the fourth link element 19d at a location 25d, being pivotally coupled to the link element 19d for angular displacement thereof about an axis transversely orthogonal to the pivot axis of the link element 19d and parallel to the axis X - - - X.

As may be gathered, the pivotal couplings between the finger-simulating digits 21a to 21d and the link elements 19a to 19d, respectively, and the pivotal couplings between the link elements 19a to 19d and the main 15a or auxiliary palm part 15b, as the case may be, collectively simulate the knuckle part of the hand.

The auxiliary palm part 15c is part, the root part, of a carrier arrangement 33. The auxiliary palm part 15c is supported in bearings 35, defining pivot axis Y - - - Y, the bearings 35 being carried by the main palm part 15a at a position adjacent to a side boundary 37 thereof, being a side boundary transversely remote from the side boundary 27.

The auxiliary palm part 15c is connected to the fifth or thumb-simulating digit 39 by a coupling part 41, the longitudinal axis L - - - L of which is forwardly inclined at an acute angle with respect to the axis Y - - - Y. The coupling part 41, which has a circumferentially extending flange 41f, is supported in bearings 41b such as to be angularly displaceable about its inclined axis Y - - - Y.

The fifth, or thumb-simulating, digit 39 is angularly displaceable with respect to coupling part 41 about an axis normal to the axis L - - - L, being, in the drawing, the axis at 39′ normal to the plane of the drawing.

The forearm portion 13 comprises a shaft 43 and a multiplicity of air muscles 45, being, in number, not less than the number of degrees of angular movement available throughout the forearm and hand configuration.

The shaft 43, being the radius-simulating portion of the forearm 13, has, at one end 43a, a pivotal coupling with an upper arm portion 46 at an elbow joint 47. The shaft 43 at its other end 43b is received within a bore 49 formed in a wrist joint-carrying stanchion 51. The stanchion 51 which is of square cross-section has a cylindrical transverse passage 51a therethrough.

The wrist-simulating joint 53 includes opposed parallel plates 55a, 55b, respectively, the one 55a being integral with or constituting a portion of the main palm, part 15, the other 55b being supported, at one end, by a side wall member 57 upstanding from the main palm part 15, and, at the other, by the stanchion 51, the plate 55b being fixed to the stanchion 51 with a portion of its inwardly facing surface 55b′ in face to face contact with a face portion of the stanchion 51, the face of the stanchion 51 that is parallel to the stanchion face portion that is in contact with the surface 55b′ being, itself, in contact with the main palm part 15. The plate portion 55a and the plate 55b have axially aligned apertures, 57a, 57b, respectively.

A universal joint between the hand and forearm portions of the configuration is constituted as a double bearing arrangement 61 having first and second bearing portions 63a, 63b, respectively.

The bearing portion 63a comprises a block 65, of square cross-section, having first, second, third and fourth passages 67a, 67b, 67c, 67d, respectively. The first passage 67a, which extends between two opposite faces of the block 65, has a cylindrical passage portion intermediate two conical end portions. The second passage 67b is a threaded cylindrical passage extending from a third face of the block 65 to communicate with the passage 65a with the axis of the passage 65b orthogonal to that of the passage 65a. The third and fourth passages 67c, 67d, are aligned with their common axis orthogonal to the axes of both the passage 65a and the passage 65b.

The block 65 is held fixed with respect to the plates 55a, 55b, screws 69a, 69b, respectively, extending through and being under clamping pressure with, the inner races 71a, 71b, respectively, of rolling bearings 73a, 73b, respectively located each with an Interference fit between the bearing outer races and respective walls of the apertures 57a, 57b.

The other portion 63b of the double bearing comprises a double rolling bearing, the outer races of which have an interference fit with the wall of the transverse stanchion passage 51a. A screw 75 Extends through the inner races of the double bearing 63b into the threaded passage 67b.

The universal joint configuration 61 permits relative movement between the hand 11 and forearm 13 about the two orthogonal axes, namely the transverse axis defined by the screw 75 and the axis normal to the latter axis, being the axis extending longitudinally of the passage 67a.

The air muscles 45, being the actuation members for inducing angular displacements between the several parts of which the configuration is composed are clustered lengthwise about the shaft 43. The muscles 45 are each anchored at one end to a local reference frame portion (not shown), not necessarily being the same reference frame portion for each muscle, being a portion (not shown) incorporated in the elbow joint 47.

The air muscles are equal in number to not less than the number of angular movements capable of being executed between the several parts of the configuration in performing the variety of movements of which the forearm, hand and the wrist joint are capable, around fifty muscles being present in the forearm for this purpose. Movement of the several elements of the configuration is effected either by a single muscle and a conventional spring or, where appropriate, by two muscles. Air muscles being, of course, capable of exerting tractive forces, only, either a conventional spring or a second muscle must be employed to effect return movement extending the first muscle to its full length preparatory to the execution of the next full working stroke of the muscle. For further general discussion of the matter here addressed reference should be made to the specification of Applicant's co-pending UK Patent Application GB No.

The objective of the design is to provide a configuration capable of performing substantially all of the functions of which the human hand, including, as examples, the ability to bring the thumb, forefinger and small finger together with their tips in contact. The hand as hereinbefore described is so capable, but as indicated, such dexterity demands the provision in the local relatively small compass of the forearm of many air muscles. Not all of these are, of course, active at any given time, but a substantial number of muscles might be so active in the performance of compound movements of the hand and wrist joint. It is important, therefore, that the muscles should present a smooth encounter with one another thereby to minimise mutual abrasion during space-seeking jostling contact therebetween. A feature of the muscle commonly the cause of such abrasion is the protuberance presented by the means employed to close the muscle at its ends.

Not infrequently, the closure means has comprised or included the common circlip, the screw-form pinion of a rack and pinion band tightening mechanism and the tail end of the clip, being liable to rise away from the encircling band portion of the clip, each constituting a hazard so far as abrasive contact between muscles is concerned.

Applicants's co-pending UK Patent Application GB No offers a favoured design for the end-closure of the muscle.

Protuberances of the sort mentioned are not present in the latter design. Liability of failure of such muscles, as a result of abrasive contact therebetween, is very substantially reduced least. The limitation of prior art forearm air muscle arrangements, the number of muscles that may be gathered around the radius, that is to say, is obviated. Whereas in prior arrangements around twelve muscles only could be incorporated in the forearm, muscle designs in accordance with the last mentioned co-pending patent application enables a full set of muscles, around forty-eight, to be employed, packed together in space-seeking jostling contact, this without subjecting the several muscles to any substantial increase in muscle failure rate under their rubbing contact.

The allusion to the muscle design of Applicant's co-pending UK Patent Application GB No is solely for the purpose of pointing to the problem encountered in at least certain prior art muscle designs, and to direct attention to a practical air-muscle configuration possessing characteristics as to the smooth muscle conformation to be sought for any air muscle suitable for employment as one of many such muscles to be incorporated in the forearm.

Returning to the matter of the configuration of the hand 11 and, more particularly, to the form of the several finger-and thumb-simulating digits each digit comprising a multiplicity of phalange-simulating segments 77, three segments in the fingers, two in the thumb. Each segment 77 comprises two spaced parallel flat plates, as 77a, 77b, respectively, the spaced plates of contiguous segments 77 overlapping at end, portions 79a, 79b, respectively, thereof and being coupled together at parallel pivot axes, as 81, orthogonal to the planes of the parallel plates 77a, 77b and intercepting said parallel plates at a position within said overlapping end portions 79a, 79b.

In the case of the finger-simulating digits 21a to 21d, though not the thumb-simulating digit 39, tendon guide wheels, as 83, are pinned to the link elements 19a to 19d, respectively.

Tendon guide posts, as 85, are respectively outstanding from the several digits, both finger and thumb, at appropriately distributed locations thereof.

The drawings are largely self-explanatory. Tendons 87 from muscles of the forearm 13 are routed by way of the passage 67a through the bearing block 65, passing around appropriate guide posts 85 and/or guide wheels, 83 for the finger-simulating digits 21a to 21d, 41f for the thumb-simulating digit 39 to optimally selected tendon fixing positions, which may be the guide post 85 positions, typically as shown, of the several relatively angularly movable parts of the hand 11, phalanges of the finger digits 21a to 21d, the thumb-simulating digit 39, relatively angularly movable members at the wrist-simulating joint 53, the radius-simulating member 49 and the main palm part 15, that is to say.

In each of the finger-simulating digits 21a to 21d, the endmost and next adjacent phalanges of the digit are biassed towards the unbent state, each by a leaf spring 88, this in order to avoid employing a tendon where this is desirable.

In addition to these features, sensors for sensing different physical variables arising both within the configuration and in the environment with which the configuration interfaces, are to be incorporated at appropriate locations of the configuration.

Movement sensors, as 89, distributed throughout the configuration at appropriate locations serve to sense relative angular movements between hand 11 with respect to the forearm 13 about the wrist joint, of the fingers 21a to 21d with respect to one another, of the thumb 35 with respect to the main palm part 15, of the several phalanges 77 of both the fingers and the thumb-simulating digits, and of the auxiliary palm parts 15a, 15b, with respect to the main palm part 15. Spacings between parallel plates 77a, 77b, of which the phalanges 77 of the several digits are constituted, serve to accommodate sensors and associated electronics.

The dexterity achievable as a result of the various combinations of independent pivotal movements permitted at the several finger-simulating joints, and particularly at the thumb-simulating joint, gives rise to a robotic hand closely comparable in the range of movements capable of being executed to that achievable with the human hand.

1. A humanoid robotic hand which comprises:
(a) a main palm-simulating portion;
(b) adjacent to each side boundary of said main palm-simulating part, first and second auxiliary palm portions said first auxiliary portion being coupled to the main palm part for pivotal movement with respect thereto about an axis transverse to the main palm part, and said second auxiliary palm portion being coupled to the main palm part for pivotal movement with respect thereto about an axis (hereinafter “fore and aft axis”) which extends in the direction orthogonal to said transverse axis;
(c) five finger-simulating digits each having a multiplicity of phalange-simulating elements articulated end-to end such as to permit angular displacement therebetween about axes which, in each said digit, extend parallel to one another transversely to the longitudinal direction of the digit;
(d) between the main palm part and the root phalange elements of the intermediate three said digits, three individual pivotal coupling means of a construction permitting angular displacement, bodily, of respective ones of said root phalange elements with respect to said main palm part each about first and second orthogonal axes, being axes that are orthogonal to the relevant root phalange in its direction of length; and in which,
(e) between the root phalange of an endmost one of said five digits, being the thumb-simulating digit, and said second auxiliary-palm-simulating portion, there is a coupling part which is supported in bearings with respect to said second auxiliary palm-simulating portion such as to be angularly displaceable about an axis acutely inclined with respect to said fore and aft axis, and to which the root phalange of the thumb-simulating digit is coupled for angular displacement about an axis orthogonal to said inclined axis and to said fore and aft axis; and,
(f) between the root phalange of the other endmost digit, being the small finger-simulating digit, and said first auxiliary-palm simulation portion, there is a coupling part which is supported with respect to said first auxiliary palm-simulating portion such as to be angularly displaceable about first and second axes orthogonal to one another and to the transverse pivot axis about which said first auxiliary palm part is pivotal with respect to the main palm part.

2. A hand as claimed in claim 1 in which: the couplings between said root phalange elements of said intermediate three and of the small finger-simulating digit each comprise an individual link element pivotal about an axis normal to the relevant palm part, main or auxiliary, and having a second pivot axis transversely orthogonal to said normal axis being the about which the root phalange element of the relevant finger is angularly displaceable.

3. A humanoid robotic hand and forearm construct which comprises:
(a) a hand as claimed in claim 1 or 2.; and,
(b) a forearm portion which comprises:
(i) shaft-form means, being the radius-simulating portion of the forearm portion, adapted at one end thereof for pivotal coupling with an upper arm portion at an elbow joint therebetween, and being coupled to said main palm portion at a side thereof opposite to its forward side at a wrist-simulating joint being a joint having a first and second pivot axes, the one permitting local relative pitch movement, the other permitting local relative yaw movement between said shaft-form means and said main palm part; and,
(ii) a multiplicity of actuator means connected each to a local reference frame portion, being, in number, not less than the number of angular movements capable of being executed by the hand and the several aforementioned constituent parts thereof; and in which, linking the several aforestated local relatively pivotal parts and said multiplicity of actuator means there is a multiplicity of tendon means respectively connected to said multiplicity of actuator means and to the several pivoted parts such as to enable angular movements as aforesaid to be executed.

4. A humanoid robotic hand and forearm construct as claimed in claim 3 and in which said actuator means comprises a multiplicity of air muscles clustered lengthwise about said shaft-form means and being each anchored at one end to a local reference frame portion of the construct, said air muscles being, in number, not less than the number of angular movements capable of being executed by the hand and the several aforementioned constituent parts thereof, and being such as to present a smooth, protruberance-free, encounter with one another, thereby to minimise mutual abrasion of the muscles during continuous jostling space-seeking contact therebetween; and in which, said radius-simulating shaft structure is coupled to said main palm part at a wrist-simulating universal joint.
